(19) United States
(12) Patent Application Publication
(10) Pub. No.: US 2007/0244727 A1
(43) Pub. Date: Oct. 18, 2007

(54) Trust Program for Providing Integrated Services for Personal Injury Settlement Clients

(75) Inventor: James Patrick Steele, Amarillo, TX (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: American International Group, Inc., New York, NY (US)

(21) Appl. No.: 11/736,661

(22) Filed: Apr. 18, 2007

Related U.S. Application Data
(60) Provisional application No. 60/792,726, filed on Apr. 18, 2006.

(51) Int. Cl. G06Q 40/00

(52) U.S. Cl. 705/4

(57) ABSTRACT

Disclosed is a Comprehensive Life Needs Trust Program that provides comprehensive services to a client who is a personal injury victim and can receive periodic payments through a settlement agreement or verdict. Such a trust program provides access to appropriate strategies to manage and protect settlement proceeds and also offers comprehensive life management tools to facilitate the day-to-day needs of the injured. These life management tools include goods and services provided for health, nursing, and handicap needs. Thus, a method of assisting a client is disclosed that includes the steps of setting up a trust program; transferring assets from a settlement to the trust program; managing, by the trust program, a structured payment program for the client; and providing additional services or goods that can include at least one of the following: home health care services or goods, durable products for disabled, prescription drug program services, and/or home maintenance service.

### CROSS-REFERENCE TO RELATED APPLICATIONS

This patent application claims the benefit of priority to U.S. Provisional Patent Application No. 60/792,726, filed on Apr. 18, 2006, which is incorporated in its entirety herein by this reference.

### FIELD OF THE INVENTION

This invention relates generally to settlement payments, and more particularly to a program for assisting victims of personal injuries to handle their settlement payments and help to manage their lives after injury.

### BACKGROUND OF THE INVENTION

Personal injury lawsuits are often settled with some portion of the settlement being paid out through a structured or periodic stream of payments. A structured settlement is a stream of periodic payments tailored to meet the anticipated future medical expenses, basic living needs and other expected expenses of the injured person. These periodic payments are funded through the issuance of an annuity from an insurance company. A long-term structured settlement payment program is often a better option than a lump sum payment, because it provides guaranteed long-term income for the victim and his/her family, and gives them the ability to adapt or recuperate from the injury and associated losses without the need to actively manage the investment of the lump sum payment. There are, however, other aspects of the life of a personal injury victim that are not adequately addressed by a structured settlement.

### BRIEF SUMMARY OF THE INVENTION

In view of the foregoing, the present invention, known as a Comprehensive Life Needs Trust Program (“CLNT Program” or “trust program”), provides personal injury victims who are entitled to receive structured settlement payments through a settlement agreement or verdict with access to trust and other vendor services. The CLNT Program addresses the unique physical and financial concerns of the personal injury settlement client by providing access to the management of not only the assets received by a client, but also to vendor goods and services to assist them in managing their lives after injury, thereby providing additional goods and services. Accordingly, in one embodiment of the present invention, a CLNT Program provides access to appropriate strategies to manage and protect settlement proceeds and also offers comprehensive life management tools to facilitate the day-to-day needs of the injured. These life management tools include access to goods and services associated with prescription drugs, home healthcare, medical equipment and durable goods, home services such as mortgages, and/or additional consumer discounts on electronics, cellular phones, restaurant and clothing stores, travel and leisure, and entertainment. In another embodiment of the present invention, life management tools include access to goods and services provided for health, nursing, and handicap needs.

In yet another embodiment of the invention, a method of assisting a personal injury client is provided that includes the steps of setting up a trust program; transferring assets from a settlement for compensating a personal injury client to the trust program; managing, by the trust program, a structured payment program for the personal injury client; and providing additional services or goods. Additional services or goods can include at least one or more of the following: home health care services or goods, durable products for the disabled and/or for medical treatment, prescription drug program services, architectural services, home maintenance services, life care planning services, and/or guaranteed-issue health insurance.

Additional features, embodiments, and details of this invention can be obtained from the following detailed description of embodiments of the invention.

### DETAILED DESCRIPTION OF EMBODIMENTS OF THE INVENTION

A study by the Tilinghast-Towers ePerrin Report, U.S. Tort Costs: 2004 update, states that the cost of tort settlements in the United States alone was $246 billion, and the patent applicant estimates that $40 billion went to compensating victims or personal injuries. About 80% of the $40 billion was distributed in cash to the claimants, who may use or invest the cash payments. When a plaintiff requires government assistance such as Supplementary Security Income and Medicaid as a result of their injuries, special-needs trusts are often the best vehicle to protect the award while ensuring the plaintiff remains eligible for the government assistance. Increasingly, arguments are made for settlement proceeds in the form of cash. Many investment alternatives are now available through financial planners, stockbrokers, bank trust departments, and other vendors.

A CLNT Program of the present invention is a way to add new features and benefits to the settlement process: access to continuous trust management and professional experience, investment management, safety, continuity of management if the claimant becomes incapacitated, estate planning and flexible comprehensive solutions tailored to the claimants needs. Surveys and research into possible needs indicate that health, wealth, and maintaining lifestyle are major concerns to claimants.

Property and casualty carriers and corporations that self insure nationwide want to settle cases favorably. From their perspective, any settlement method that improves case management is a benefit. The CLNT Program of the invention provides a way to resolve settlement issues that can be used separately or in combination with the core structured settlement annuity. The CLNT Program of the invention now has a greater opportunity to define solutions that can speed the settlement process.

A trust account provides professional management of assets and a means for protecting those assets from creditors, persons who would advise dubious investments, inexperienced or imprudent beneficiaries. Trusts serve the needs of physically challenged beneficiaries and meeting the goals of the trustor such as education, retirement income and contingent medical needs, as well as offering complete financial records and accurate tax information.

It is helpful to understand the concept of a typical claims lifecycle to fully understand the need for providing access to trust services to manage a structured settlement. In any particular case involving a physical injury, the plaintiff alleging a wrong can file a lawsuit or claim. The defendant typically hires an attorney to defend its position and the negotiations begin. The parties may agree to a negotiated settlement, or, if they do not agree, the lawsuit goes to trial and a verdict is decided in court.

Once the claim/lawsuit has been resolved, the claimant must decide how to accept the settlement proceeds. They must choose to take the settlement all in cash, all in a structured annuity, or a combination of the two. Frequently, as part of the negotiation or per the court's decision, the choice of how the settlement is to be paid is predetermined. For example: in the case of an injured minor, the court may require that a certain amount of the settlement proceeds be placed into a Special Needs Trust.

A trust services component of the CLNT Program invention can be provided by a nationally chartered trust company authorized to administer trusts from all fifty states. The company can adhere to the philosophy to operate with a firm commitment to personalized relationships by offering a robust portfolio of products. The financial strength of the company providing the trust service component of the CLNT Program can be expected to be strong to ensure the highest quality trust service for its clients. The trust program can build relationships with its clients, the injured claimants and their caregivers, and the trust program can function as a partner, taking an active role in serving as a reliable resource in helping its clients build and maintain better lives and providing professional management of settlement recoveries.

Generally, a trust is a legal relationship in which the grantor (creator of the trust) transfers property to a trustee (an individual or an institution) a trust company) to hold and manage for the benefit of one or more beneficiaries. The trust document, drafted by an attorney, sets forth the grantor's desires as to the duration of the trust, the powers and duties to be given the trustee, the time and manner of the distribution of the trust income and principle, and the rights of the beneficiaries. The grantor gives the trustee legal title to the trust property and the trustee is legally bound to manage, invest, and disburse that property in the manner described in the trust document and in accordance with the current law.

A special needs trust is designed to allow a disabled beneficiary to retain assets without disqualifying him or her from government benefits, such as Supplementary Security Income (SSI) and Medicaid. This allows the beneficiary to continue to receive the valuable government benefits available while using the trust to supplement his or her needs. Without a special needs trust, a person may not qualify for government benefits and may be required to spend the money in the trust before qualifying for government assistance. Also, depending on the type of special needs trust; there may be provisions that require the repayment of state Medicaid money upon the death of the beneficiary or at the termination of the trust. Under current conditions, the trust must be deemed irrevocable to qualify as a special needs trust.

An irrevocable trust cannot be amended, revoked or terminated. A permanent election was made by a person of proper authority to change the legal title of the assets to that of the trustee when they are placed in an irrevocable trust. This permanent relinquishment of control over the trust assets may give the trust the power to control potential estate taxes and possibly protect the assets from the claims of future creditors and/or in the case of divorce.

Whether a trust is irrevocable or revocable, two aspects of creating a trust are asset management and disability planning. Creating a trust can help ensure assets are managed pursuant to the terms of the trust.

A vendor services component of a CLNT Program is a distinguishing feature of the invention in that it can offer access to various product and service distribution channels for health, nursing, handicap needs and more that are tailored to assisting clients of personal injury settlements. It differentiates itself not only through providing access to money management, but also through innovative product design and comprehensive life need tools. It can become the cornerstone of the recipient's daily routine. To that end, the CLNT Program has identified and continues to identify products and services designed specifically for its client's needs as victims of physical injury.

A trust services component of the CLNT Program is based on the understanding that individuals who receive settlements have unique circumstances. Its goal is to understand those individual needs and provide an array of products and services to help manage those daily-specialized needs. These preferably can all be contained in a single-source order and delivery environment created by the trust program and investment portfolio designed to meet those needs. The CLNT Program can be a provider of global financial solutions for the investment management, asset administration, fiduciary and banking needs of physical injury recipients.

Some products and services channels suitable for use with a CLNT Program of the present invention are described below.

1. Nursing/Attendant Care/Home Health Care Services

Health care today is based on a professional health care team working toward a common goal. Today, home health care may be considered for patients who are recovering from an illness, undergoing treatment, disabled, chronically ill, or terminally ill. Home health care can be categorized into two groups: (1) standard home health care, and (2) hospice care—provided for terminally ill patients who prefer peace, comfort, and dignity of being at home. The trust program can work with those who need home health care and give them support by referring them to service providers such as: home health agencies, homemaker and home care aide agencies, pharmaceutical and infusion therapy companies, durable medical equipment dealers, staffing registries and private duty agencies, and independent providers, for example.

2. The trust program can also direct its trust clients to sources that help them pay for home health care, such as, Medicare, Medicaid, Veteran's Administration, Social Services Block Grants, Community Organizations, Commercial Health Insurance, Civilian Health and Medical Program of the Uniformed Services (CHAMPUS), worker's compensation, and Managed Care Organizations, for example. The trust program can refer to resources that facilitate an intake checklist to determine the quality of provider(s) a patient/client is looking to use. The checklist can include Licensure, Bonding, Certification and Accreditation considerations, for example.

3. Durable Products

The trust program can offer durable goods products by partnering with suppliers to attain discounted prices. Durable goods can include devices to help disabled clients and/or to provide medical treatment such as: wheelchairs, diabetic shoes, bed and bath products, walkers, rollators, power scooters, oxygen therapy, lift chairs, electrotherapy, syringes, and daily living aids, etc.

4. Life Care Planning

Catastrophic injury and chronic illness can be a devastating event that affects not only the individual and family, but also those who provide the care. Specialized services may be required for the remainder of a person's lifetime. Due to advances in medical research and technology, people are living longer; consequently the need for long term care has increased. A Life Care Plan is a dynamic document based upon published standards and practices. It can include a comprehensive assessment, data analysis and research that provide an organized, concise plan for current and future needs, with associated costs, for an individual who has experienced catastrophic injury or has chronic health care needs. The Life Care Plan can:
a. Provide education as to functional impact of disabilities
b. Assess future health, medical, equipment, and supportive care needs utilizing a multiple disciplinary approach
c. Develop options and alternatives that may become necessary
d. Provide a comprehensive detailed plan outlining specific, current and future needs, services, frequencies, duration and costs
e. Educate and provide a working guideline and a reference for the disabled person, the family, and all third parties (i.e. attorneys, insurance carriers, and judicial system)
f. Increase the awareness of, and reduce the likelihood of potential complications.

5. The trust program can refer, and establish relationships with, personal Life Care Planners for trust clients by working through organizations such as the American Association of Nurse Life Care Planners, Gisclair and Associates, Durable Medical Equipment, Inc., for example and through various licensed planners or vendors located across the United States.

6. Guaranteed-Issue Health Insurance

The trust program can work with clients to help find plans that can enable most to obtain some level of insurance coverage for medical expenses. One such plan for instance is in Ohio, where the guarantee issue Basic Plan 400 includes; daily hospital benefits, intensive care benefits, initial hospitalization rider, accident benefit, outpatient sickness, prescriptions, and surgical & anesthesia benefits.

7. Home Maintenance and/or Architectural Services for Handicapped Needs

The preservation of quality of life and independence can be greatly affected when homes are not adequately designed or renovated to allow mobility and accessibility for handicapped individuals. The choices and problems involved in any architectural project can be bewildering and complex. The services and consulting that these companies have uniquely tailored for handicap redesign and new construction can greatly benefit our clients. The trust program can work diligently with these companies to provide not only referral services, but price discounts as well.

8. Mail Order Prescription Drug Service

A prescription discount program, such as from Medco Health, can give clients freedom and convenience when purchasing prescriptions, as well as, offering discounts. Further, if medicines ordered on a regular basis are purchased through a home delivery pharmacy service, such as the one offered by Medco, for example, clients can receive greater discounts. The prescription discount program is available to all Medicare beneficiaries nationwide, except those who have prescription drug coverage under their state's Medicaid program or those who are enrolled in a Medicare managed care plan that offers its own exclusive Medicare-approved drug discount card. The program is approved by Medicare, but it is not a Medicare benefit, and is not intended to replace prescription drug benefits obtained through participation in insurance plans including a Medicare+choice plan, a Medigap policy, Medicaid, or an employer plan. The trust program can deepen and strengthen its relationship with its clients and their advisors by offering referrals and support to these plans.

9. Trust Services

Settlement trusts are becoming ever popular as an alternative for, or at least a complement with, annuity-based structured settlements. The trust program can offer the services typically provided by trusts of the following types:
a. Special Needs Trust—These vehicles can be used to administer tort recoveries for plaintiffs who want to maintain their eligibility for public assistance. A fundamental objective of using a Special Needs Trust is to leverage the beneficiary's health-care costs, first from available public-benefit finds and only then from the discretionary trust. The grantor's intent is to use trust income and principal as a supplement to benefits and support provided by governmental programs, and is intended to preserve a disabled beneficiary's eligibility for Medicaid and Supplemental Security Income (SSI).
b. Medicare Set-Aside (“MSA”) Trust—An MSA allocation can be set up with funds from a settlement to be used for the sole purpose of paying for Medicare-allowable medical expenses. The funds are to be used specifically for those expenses relating to injury that would otherwise be covered by Medicare. There is a special point of emphasis that claimants must adhere to maintain their MSA, created by the Centers for Medicare and Medicaid Services (CMS). The comprehensive trust program can be a beneficial part of a client's settlement by helping monitor, preserve, and protect their MSA through the trust services.

10. Handicap Camp Referral Services

The trust program can further strengthen its relationship with clients and their advisors by taking an integral part in the referral of those with disabilities to camps that offer a positive experience. Programs such as the Texas Lions Camp and Camp Prospects provide outdoor camping experiences to handicapped children, letting them enjoy many activities including; swimming, horsemanship, ropes courses, arts & crafts, nature studies, animal science and horticulture, music, drama, recreation and athletics, shooting sports and overnight/outdoor campouts.

11. Handicap Van/Auto Conversion

Along with handicap camp referrals, the trust program can refer resource needs for handicap auto/van conversions by companies such as IMS, which manufactures mobility vans and Rollx Vans which can provide a conversion for an existing van. The IMS Rampvan offers superior engineering and design. It's the first to be crash tested, offer the most carrying capacity, more headroom, more interior space and the fastest ramp deployment and retraction. Rollx Vans specializes in handicap van conversions.

In another embodiment of the invention, a CLNT Program includes a method of delivering preferred price goods and services through a convenient mail-order, fax, telephone, or internet type system capable of providing access to discounted life enhancement goods and services. The CLNT Program also includes access to direct durable medical equipment, medical services companies, a prescription drug service, and connections for home maintenance. The trust also includes access to a trust bank for conventional trust services including investment management, client communications and trust fiduciary and administration services. Accordingly, the invention provides both conventional trust services and comprehensive life need services to settlement recipients.

In one embodiment of the invention, a CLNT Program is accessed through a secure internet web provider with effectively personalized and advantaged concierge-like services that can also be accessed by phone, fax and/or regular mail, such that preferred prices are provided on health savings, clothing, entertainment, dining, travel, airlines, hotels, office goods, internet services, package delivery services, etc. For convenience, this aspect is described as a “web provider” and it should be noted that this term is intended to encompass any means, channel, and/or method of providing access to the trust including internet, phone, fax, and/or mail techniques known to those of ordinary skill in the art of the invention. The web provider can also access a direct durable medical equipment provider billed at preferred pricing that can offer medical equipment such as ambulation aids, bathroom aids, exercise equipment, diabetic supplies, home modification devices (such as ramps, showers, facilities, chair lifts, cabinets, countertops, bathtubs, shower grab bars, toilets, mirrors, and storage), vehicle modification devices (such as custom vans, van conversions, wheelchair lifts, hand controls), etc. The web provider can also access a home health/medical services provider billed at preferred pricing to provide local or national home nursing care, including access to RN, LPN, nurse-care case coordinators, medical assistance/home health aides, companion services (for eating, dressing, shopping etc.), and licensed therapists (for physical, speech, or occupational needs). The web provider can also access a discounted prescription drug service, including access to tailored prescription plans to help clients reduce overall drug costs and insurance requirements. The web provider can also access a home maintenance service including a broad coverage of contractors providing home services such as maid services, handyman services, lawn care, pest care, heating and air conditioning repair, home security, etc. Home services can also include home buying and selling, moving services, utility connections, temporary living arrangements, and home protections (insurance, warranty, mortgage protection, locksmith, inspection, etc.).

In another embodiment of the invention, by utilizing renowned money managers with years of investment experience, a CLNT Program for settlement recipients and its custodian, the trust services component of the CLNT program, can manage trusts and custodial accounts with safe, high quality and cost efficient trust administration service. The CLNT Program for settlement recipients can provide access to the infrastructure, specialized computer support and processing systems needed to properly manage and service personal injury settlement trusts including Special Needs Trusts and Medicare Set-Aside Trusts. Additional types of trusts can be created as particular investment vehicles to support conventional trust needs and objectives as understood by those of ordinary skill in the relevant art. Accordingly, in this aspect of the invention a customized structured payment program can be created for a personal injury client, which bolsters other aspects of the comprehensive trust related to managing the client's daily life after injury with provisions of additional goods and services.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of assisting a personal injury client, comprising:
(a) setting up a trust program;
(b) transferring assets from a settlement for compensating a personal injury client to the trust program;
(c) managing, by the trust program, a structured payment program for the personal injury client; and
(d) providing additional services or goods by the trust program to assist the personal injury client, the, additional services or goods selected from the group consisting of home health care services or goods, durable products for disabled, life care planning services, prescription drug program services, and combinations thereof.

2. The method of claim 1 wherein the payment program comprises a Special Needs trust.

3. The method of claim 1 wherein the payment program comprises a Medicare Set-Aside trust.

4. The method of claim 1 wherein the additional services or goods further comprise consumer discounts on clothing entertainment, dining, travel, airlines, hotels, office goods, internet services, or package delivery services.

5. The method of claim 1 wherein the additional services or goods further comprise architectural services for needs of disabled.

6. The method of claim 1 wherein the durable products for the disabled are provided and comprise products selected from the group consisting of ambulation aids, bathroom aids, exercise equipment, diabetic supplies, home modification devices, vehicle modification devices, and combinations thereof.

7. The method of claim 6 wherein the home modification devices comprise at least one device selected from the group consisting of ramps, showers, facilities, chair lifts, cabinets, countertops, bathtubs, shower grab bars, toilets, mirrors, and storage.

8. The method of claim 6 wherein the vehicle modification devices comprise at least one device selected from the group consisting of custom vans, van conversions, wheelchair lifts, and hand controls.

9. The method of claim 1 wherein the home health care services or goods are provided and further comprise assigning the client at least one person selected from the group consisting of a RN, a LPN, a nurse-care case coordinator, a medical assistance/home health aide, a licensed therapist, and combinations thereof.

10. The method of claim 1 wherein the additional services or goods further comprise a home maintenance service comprising at least one service selected from the group consisting of maid services, handyman services, lawn care, pest care, heating and air conditioning repair, home security, home buying and selling, moving services, utility connections, temporary living arrangements, home insurance, home warranty, mortgage protection, locksmith, and combinations thereof.

11. The method of claim 1 wherein at least one of steps (c) and (d) is performed with a computer to provide access to payments and/or to said goods or services.

12. The method of claim 1 wherein the additional services or goods further comprise guaranteed-issue health insurance.

13. A method of assisting a personal injury client, comprising:
(a) setting up a trust program comprising at least one trust form selected from a Special Needs trust and a Medicare Set-Aside trust;
(b) transferring assets from a settlement for compensating a personal injury client to the trust program;
(c) managing, by the trust program, a structured payment program for the personal injury client comprising future periodic payments and associated tax transaction disclosures; and
(d) providing at least one additional service or good by the trust program to assist the personal injury client by using a computer, mail, fax, or telephone interface, wherein the additional service or good is selected from the group consisting of home health care services or goods, durable products for disabled, guaranteed-issue health insurance, prescription drug program services, home maintenance service, and combinations thereof.

14. The method of claim 13 wherein the durable products for the disabled are provided and comprise products selected from the group consisting of ambulation aids; bathroom aids; exercise equipment; diabetic supplies; home modification devices selected from the group consisting of ramps, showers, facilities, chair lifts, cabinets, countertops, bathtubs, shower grab bars, toilets, mirrors, and storage; vehicle modification devices selected from the group consisting of custom vans, van conversions, wheelchair lifts, and hand controls; and combinations thereof.

15. The method of claim 13 wherein the home health care services or goods are provided and further comprise assigning the client at least one person selected from the group consisting of a RN, a LPN, a nurse-care case coordinator, a medical assistance/home health aide, a licensed therapist, and combinations thereof.

16. The method of claim 13 wherein the additional services or goods further comprise a home maintenance service comprising at least one service selected from the group consisting of maid services, handyman services, lawn care, pest care, heating and air conditioning repair, home security, home buying and selling, moving services, utility connections, temporary living arrangements, home insurance, home warranty, mortgage protection, locksmith, and combinations thereof.

17. A computer-based method of assisting a personal injury client, comprising:
(a) setting up a trust program comprising at least one trust form selected from a Special Needs trust and a Medicare Set-Aside trust;
(b) transferring assets from a settlement for compensating a personal injury client to the trust program;
(c) managing, by the trust program using a computer interface, a structured payment program for the personal injury client comprising future periodic payments and associated tax transaction disclosures; and
(d) providing at least one additional service or good by the trust program using a computer interface to assist the personal injury client, wherein the additional service or good is selected from the group consisting of home health care services or goods, durable products for disabled, guaranteed-issue health insurance, prescription drug program services, home maintenance service, and combinations thereof.

18. The method of claim 17 wherein the additional services or goods further comprise consumer discounts on clothing entertainment, dining, travel, airlines, hotels, office goods, internet services, or package delivery services.

19. The method of claim 17 wherein the additional services or goods further comprise architectural services for needs of disabled.

20. The method of claim 17 wherein the additional services or goods further comprise handicap camp referral services.
